(19) United States
(12) Patent Application Publication
(10) Pub. No.: US 2010/0161895 A1
(43) Pub. Date: Jun. 24, 2010

(54) Securing data on data cartridges

(76) Inventors: William R. Qualls, River Falls, WI (US); Kevin G. Battles, El Paso, TX (US); Jody L. Gregg, Lake Elmo, MN (US); Robert S. Jackson, Little Canada, MN (US); C. Thomas Jennings, Woodbury, MN (US)

Correspondence Address: Shumaker & Sieffert. P.A., 1625 Radio Drive, Suite 300, Woodbury, MN, 55125, US

(21) Appl. No.: 12/317,344

(22) Filed: Dec. 22, 2008

(51) Int. Cl. G06F 12/14; G06F 12/00

(52) U.S. Cl. 711/111; 711/163; 711/166; 711/E12.001; 711/E12.092; 711/E12.091

(57) ABSTRACT

Techniques are described for securing data on data cartridges, such as a Linear Tape-Open (LTO) data cartridge. The techniques include modifying a portion of a cartridge memory (CM) chip of the cartridge in a way that a cartridge drive will be unable to access the data cartridge and to prevent modification of the CM chip by the cartridge drive. In one embodiment, a system includes a data cartridge including a CM chip, a chip reader to read data from and write data to the CM chip, and a computing device to control the chip reader. The computing device causes the chip reader to read data from the cartridge memory chip of the data cartridge and to modify a portion of memory of the chip to prevent unauthorized reads and writes to the data cartridge, without rendering the modification irreversible.

### TECHNICAL FIELD

The invention relates to magnetic data storage media and, more particularly, to cartridge memory chips of magnetic tape data cartridges, for example, Linear Tape-Open data cartridges.

### BACKGROUND

Increases in the amount of data handled by computer systems have led to demands for data storage back up devices that use magnetic tape. Magnetic tape media remains an economical medium for storing large amounts of data. For example, magnetic tape cartridges, or large spools of magnetic tape are often used to back up large amounts of data for large computing centers. Magnetic tape cartridges also find application in the backup of data stored on smaller computers such as workstations, desktop, or laptop computers.

Automated cartridge libraries provide access to vast amounts of electronic data by managing magnetic data tape cartridges. Automated cartridge libraries exist in all sizes, ranging from small library systems that may provide access to twenty or fewer data cartridges, to larger library systems that may provide access to thousands of data cartridges.

One type of data storage system includes a linear tape drive. For example, Linear Tape-Open (LTO) data cartridges are representative of linear tape products. Conventional LTO cartridges, for example, include a cartridge memory chip (CM chip) that may be a radio-frequency identification (RFID) chip. The CM chip may be affixed to or within a housing of the tape cartridges. LTO drives typically include an RFID interface that enables the drive to read and/or write data to the CM chip of an LTO cartridge. An LTO drive may read and write data to the CM chip via a contactless radio frequency interface. The data on the CM chip may indicate the last four drive mounts, recent performance data, and the amount of information stored on the cartridge. For example, each time a tape cartridge is loaded or unloaded from a drive, the library system may read the CM chip and store the read data in the database. Other types of linear tape cartridges with similar radio frequency chips include IBM 3592 data cartridges and Sun T10000 data cartridges. Future tape cartridges will likely use CM chips as well.

### SUMMARY

In general, techniques are described for protecting data on a data cartridge, such as a Linear Tape-Open (LTO) data cartridge. In accordance with the techniques described herein, a tape drive or other device for reading and writing a cartridge memory (CM) chip of a data cartridge manipulates information of a CM chip of a particular data cartridge to protect data on the corresponding cartridge. A CM reader may, in accordance with the techniques described herein, modify the CM chip in such a way that a cartridge drive will be unable to access data of the data cartridge, i.e., the cartridge drive will be unable to read data from and write data to the data cartridge. The cartridge may then be stored in a remote location until the cartridge is returned to a trusted party who may reverse the manipulation of the CM chip to make the cartridge accessible. In this manner, the cartridge may be protected from access by drives that are not equipped to undo the modifications made to the CM chip. In one embodiment, the CM reader may be part of a cartridge drive. In another embodiment, the CM reader may be a stand-alone CM-chip-reading device. As one example, the CM reader may encrypt or relocate portions of the CM chip within the CM chip. As another example, the CM reader may modify values of certain portions of the CM chip to be incorrect, but to conform to the standard requirements. As another example, the CM reader may relocate portions of data of the chip within the CM chip or stored in a separate storage unit until a trusted party needs to read the data of the data cartridge.

In one embodiment, a method includes reading a cartridge memory chip associated with a data cartridge and modifying a portion of memory of the chip to prevent access to data of the data cartridge, without rendering the modification irreversible.

In another embodiment, a system includes a data cartridge that includes a cartridge memory chip, a chip reader to read data from the cartridge memory chip and to write data to the cartridge memory chip, and a computing device to control the chip reader, wherein the computing device causes the chip reader to read data from the cartridge memory chip of the data cartridge and to modify a portion of memory of the chip to prevent access to data of the data cartridge, without rendering the modification irreversible.

In another embodiment, a data cartridge includes a magnetic tape to store data, and a cartridge memory chip, wherein the cartridge memory chip includes at least one page that does not conform to a standard for the data cartridge, wherein the at least one non-standard page prevents a cartridge drive from reading the data stored on the magnetic tape and prevents the cartridge drive from overwriting the data stored on the magnetic tape, wherein the at least one non-standard page can be modified to allow access to data of the magnetic tape.

In another embodiment, a computer-readable medium contains instructions. The computer readable medium may be a computer-readable storage medium. The instructions may, for example upon execution, cause a programmable processor to read a cartridge memory chip associated with a data cartridge, and modify a portion of memory of the chip to prevent unauthorized access to data of the data cartridge, without rendering the modification irreversible.

The techniques described herein may provide several advantages. For example, these techniques may provide protection for data of a data cartridge without encrypting data of the data cartridge itself. Instead, only data of the CM chip may be modified, such as through encryption, relocation, or modification, to prevent a cartridge drive from being able to readily access the data of the data cartridge. Moreover, the techniques may be reversible and may confuse a cartridge drive to the point that the cartridge drive will not be able to access, i.e., read or write, data of the data cartridge. The techniques also allow protection of data cartridge after the data has been written to the data cartridge, i.e., without requiring rewriting of data to the data cartridge when the data cartridge already includes data. The techniques may also be implemented in a chip reader that is not part of a cartridge drive.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system for protecting data of a Linear Tape-Open (LTO) data cartridge.

FIG. 2 is a block diagram illustrating an example set of modifiable pages of a cartridge memory (CM) chip of an LTO data cartridge.

FIG. 3 is a block diagram illustrating an example initialization page of a CM chip.

FIG. 4 is a block diagram illustrating an example method for protecting data on an LTO cartridge.

FIG. 5 is a flowchart illustrating an example method for reversing the protective measures discussed with respect to FIG. 4.

FIG. 6 is a flowchart that illustrates an example method for protecting a data cartridge by setting a vendor specific flag.

FIG. 7 is a flowchart illustrating an example method for protecting a data cartridge by changing linear position values of an initialization page of a CM chip.

### DETAILED DESCRIPTION

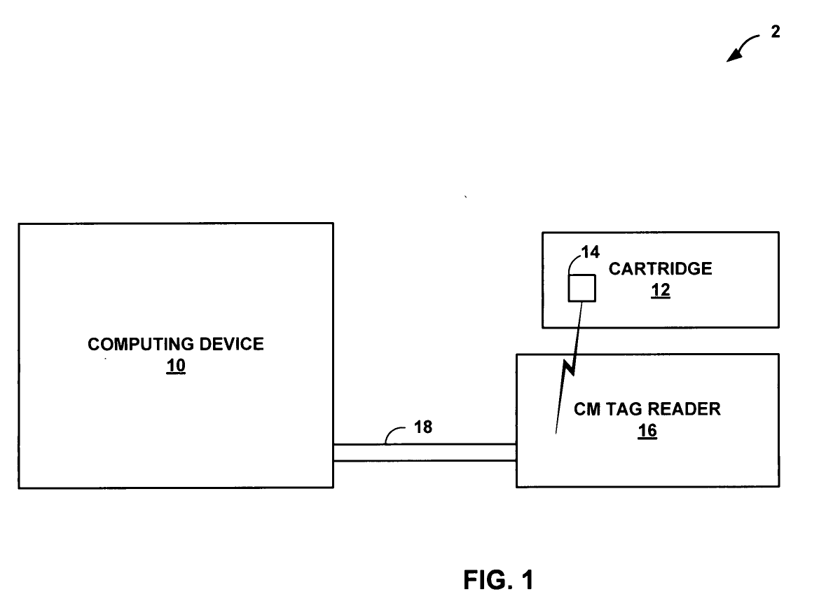

FIG. 1 is a block diagram illustrating an example system 2 for protecting data of Linear Tape-Open (LTO) cartridge 12. Although the example of FIG. 1 is described with respect to an LTO cartridge, the techniques discussed herein are applicable to other data cartridges as well, such as, for example, IBM 3592 data cartridges and Sun T10000 data cartridges. Generally, the techniques of this disclosure may apply to any data cartridge that includes a cartridge memory (CM) chip.

In the example of FIG. 1, LTO cartridge 12 includes CM chip 14. In one embodiment, CM chip 14 may be a radio frequency identification (RFID) tag that is adhered to or within a housing of cartridge 12. CM tag reader 16, in one embodiment, is capable of reading data from and writing data to CM chip 14. CM tag reader 16 may be capable of reading and writing data of CM chip 14 at a distance of, for example, 10 mm. In one embodiment, CM tag reader 16 may be a stand-alone tag-reading device. In another embodiment, CM tag reader 16 may be a cartridge drive designed to read data from and write data to cartridge 12. In one embodiment. CM tag reader 16 may be a Baltech reader, commercially available from Baltech AG of Germany.

CM chip 14 may be a chip conforming to the LTO-CM standard. In general, LTO-CM chips are used to identify the cartridge and information about the cartridge. Certain portions of CM chip 14 can be modified, while other portions cannot be modified. For example, CM chips generally include a read-only section that identifies the manufacturer of the CM transponder, cartridge manufacturer information, and media manufacturer information. CM chips also generally include a re-writeable section that includes initialization data when a format is initialized or reinitialized, usage information, a tape directory, EOD information, mechanism manufacturer information, and application specific data. CM chips may also identify the type of the associated cartridge, for example, as a cleaning cartridge, a write once read many (WORM) cartridge, or a vendor-specific cartridge.

In accordance with one standard, for example, a CM chip, such as CM chip 14, includes 128 blocks, each of which is 32 Bytes, for a total CM chip storage capacity of 4096 Bytes. Other standards specify other maximum storage capacities for CM chips. For example, another standard may specify that a CM chip has a storage capacity of 8160 Bytes. Certain pages of CM chip 14 may be modifiable, while other pages may be unmodifiable by an LTO compliant drive. In accordance with the techniques described herein, CM tag reader 16 may modify one or more of the modifiable pages of CM chip 14 in such a way that, when a cartridge drive attempts to access cartridge 12, the cartridge drive will be unable to read data from or write data to cartridge 12. Moreover, in accordance with the techniques described herein, CM tag reader 16 may modify pages of CM chip 14 in such a way that the tape drive will not attempt to overwrite or otherwise modify data of CM chip 14. Furthermore, in accordance with the techniques described herein, CM tag reader 16 may modify data of CM chip 14 such that only CM tag reader 16 may be able to reverse the modification to data of CM chip 14 in order to permit a tape drive to subsequently access the tape drive. In one embodiment, CM tag reader 16 may be included in a cartridge drive, in which case the cartridge drive that includes CM tag reader 16 may be capable of implementing the techniques of this disclosure when the cartridge drive attempts to access cartridge 12. In this manner, CM tag reader 16 may secure data on cartridge 12 without actually modifying, e.g., encrypting, data of cartridge 12 itself.

In the example of FIG. 1, system 2 includes computing device 10 coupled to CM tag reader 16 via link 18. In one embodiment, link 18 between computing device 10 and CM tag reader 16 may include an RS232 interface. In another example embodiment, CM tag reader 16 may include one or more modules, either in hardware or in software, to perform the functions described with respect to computing device 10. Computing device 10 may control CM tag reader 16 to modify data of CM chip 14 to secure data on cartridge 12. In one embodiment, computing device 10 may be a stand-alone computer. In another embodiment, computing device 10 may be a workstation computer. In another embodiment, computing device 10 may be a specialized computer designed solely to interact with CM tag reader 16. In general, computing device 10 may cause CM tag reader 16 to read data from and write data to CM chip 14 to prevent cartridge drives from accessing cartridge 12 and to prevent unauthorized drives from overwriting data on CM chip 14. In one embodiment, CM tag reader 16 may be included in a cartridge drive, in which case unauthorized drives would be prevented from accessing data of cartridge 12, but the cartridge drive including CM tag reader 16 would be capable of accessing data of cartridge 12 by reversing the modification to CM chip 14. Other drives, in another embodiment, may also be authorized to reverse the modification to CM chip 14, e.g., by providing the drives with a key for decrypting encrypted pages of CM chip 14.

CM tag reader 16 may modify data of CM chip 14 in one or more of several ways, as described in the examples below. In general, the modification is such that, when a cartridge drive attempts to access cartridge 12, first reading data from CM chip 14, the cartridge drive will be unable to access cartridge 12. The modifications may also prevent a cartridge drive from overwriting or otherwise modifying data of CM chip 14. Detailed examples are given below. As one example, CM tag reader 16 may encrypt a page of CM chip 14. When the page includes cyclical redundancy check (CRC) bytes, CM tag reader 16 may reset the CRC bytes such that, when the page is read by a cartridge drive, the cartridge drive will be unable to read the page (due to the encryption) but the drive will determine that nothing is wrong with the page, due to the CRC bytes. When the CRC bytes of a page are inaccurate, thus causing a cyclical redundancy check to fail, a cartridge drive may determine that data of the data cartridge is corrupted, and therefore that data of the data cartridge may be overwritten. Accordingly, CM tag reader 16 also recalculates CRC bytes of a page that has been modified when the page includes CRC bytes to prevent a cartridge drive that attempts to access the data cartridge from rewriting data of the CM chip. CM tag reader 16 writes the recalculated CRC bytes to the page after the page has been modified, in the proper location of the modified page.

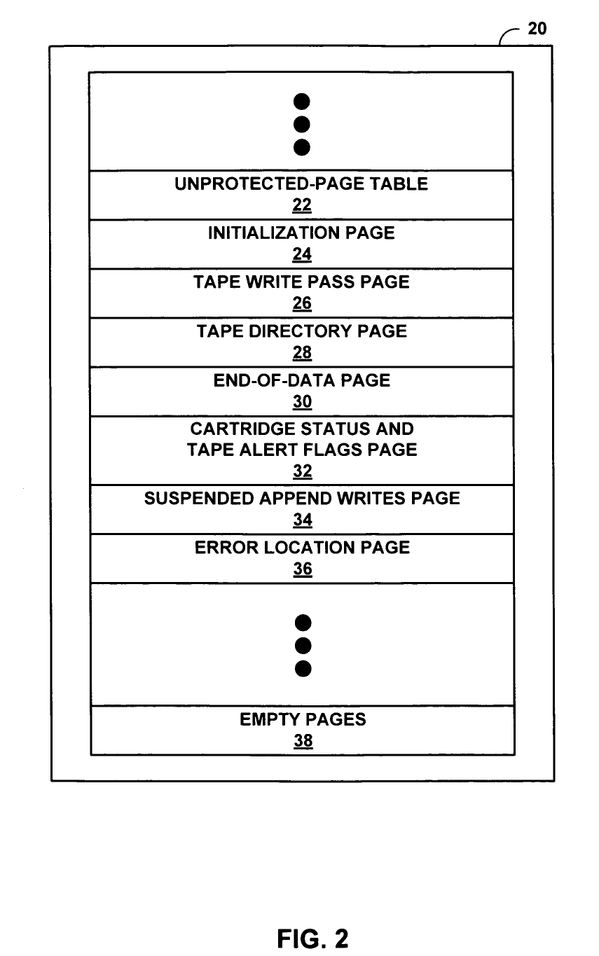

FIG. 2 is a block diagram illustrating an example set of modifiable pages of CM chip 20 of a data cartridge. FIG. 2 does not necessarily show each and every page of a CM chip, but FIG. 2 depicts certain pages that CM tag reader 16 may modify in various ways, in accordance with the techniques described herein, to prevent unauthorized access, i.e., reads and writes, of data on the corresponding data cartridge. CM chip 20 may, in one embodiment, correspond to CM chip 14 of FIG. 1. In the example of FIG. 2, CM chip 20 is a CM chip for an LTO-3 data cartridge. LTO-1 and LTO-2 (i.e., LTO generation one and generation two) cartridges include many of the same or similar pages. In the example of FIG. 2, CM chip 20 includes unprotected-page table 22, initialization page 24, tape write pass page 26, tape directory page 28, end-of-data (EOD) page 30, cartridge status and tape alert flags page 32, suspended append writes page 34, error location page 36, and empty pages 38. A chip reader, such as CM tag reader 16, modifies a plurality of these pages to prevent unauthorized access to data of the data cartridge corresponding to CM chip 20. In some embodiments, CM tag reader 16 modifies a specific subset of the pages of CM chip 20 in a combination that prevents a plurality of models of cartridge drives from reading or writing data to the data cartridge that includes CM chip 20.

Unprotected-page table 22 may include a set of N page descriptors, where N is the number of unprotected pages in CM chip 20, and a CRC field. Each page descriptor may comprise a set of four bytes that describes, for the corresponding page, the page version (4 bits), the page ID (12 bits), the starting address of the most significant byte (8 bits), and the starting address of the least significant byte (8 bits). The CRC bytes of unprotected-page table 22 may be calculated using Reed-Solomon codes over GF-286. This algorithm may generally be used to recalculate any CRC bytes of any page that includes CRC bytes.

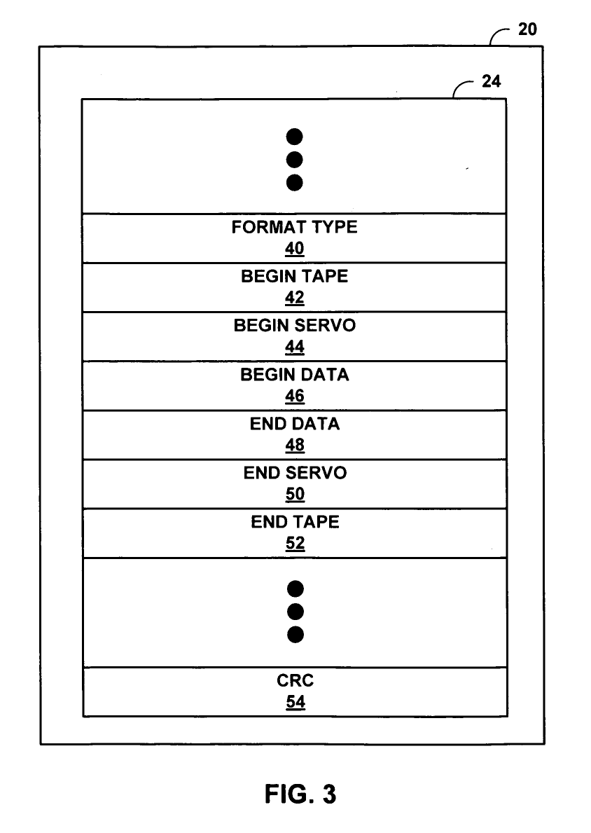

In one embodiment, to render data of the cartridge unreadable, CM tag reader 16 may encrypt unprotected-page table 22. In this manner, a cartridge drive will not be able to locate any of the other unprotected pages. CM tag reader 16 may also recalculate the CRC bytes at the end of unprotected-page table 22 to maintain the integrity of the data stored on the data cartridge. In another embodiment, CM tag reader 16 may move all of the data of unprotected-page table 22 to one of empty pages 38 of CM chip 20. CM tag reader 16 may also encrypt the copied data of unprotected-page table 22 stored in the one of empty pages 38. Initialization page 24 is discussed in greater detail with respect to FIG. 3.

Tape write pass page 26, in accordance with the LTO standard, is a 48 Byte page with page ID “102.” In general, tape write pass page 26 stores write pass information for each wrap of the corresponding cartridge. CM tag reader 16 may encrypt the contents of tape write pass page 26 to prevent access to data of the data cartridge. In accordance with the standard, the sum of the eight 4-Byte fields of tape write pass page 26 may equal the tape write pass value, which is to be equal to the largest value of write pass recorded in any codeword recorded on the cartridge. Where (tape write pass value) mod 8 is 0, all eight of the 4-Byte fields are to be the same value; otherwise, fields 0 to (N-1) are to be one greater than fields N to 7, where N=(tape write pass value) mod 8. CM tag reader 16 therefore ensures that the encrypted version of tape write pass page 26 follows these requirements of the standard.

Tape directory page 28, in accordance with the LTO-1 standard, for example, is 1552 Bytes with page ID “103,” having 16 bytes per wrap section of the cartridge, with 96 wrap sections. The other 16 bytes of tape directory page 28 are devoted to a page ID, page length, and 12 bytes that are reserved or ignored. In general, tape directory page 28 records a record count and file mark count for each wrap on the cartridge and is used to find data on the tape of the cartridge. CM tag reader 16 may encrypt the contents of tape directory page 28 to prevent read access to data of the data cartridge. In other embodiments, tape directory page 28 may include a different number of bytes to conform to a different LTO standard. Tape directory page 28 also typically includes CRC bytes that are recalculated after tape directory page 28 has been encrypted by CM tag reader 16.

End-of-data page 30, in accordance with the LTO standard, is a 64 Byte page with page ID “104.” In general, end-of-data page 30 contains information that identifies the location of the end of data (EOD) of the cartridge. This information allows a drive to find the end of the existing data in order to write additional data to the cartridge. CM tag reader 16 may encrypt the contents of end-of-data page 30 to prevent unauthorized access to data on the cartridge. CM tag reader 16 also recalculates CRC bytes at the end of end-of-data page 30 in accordance with the CRC algorithm discussed above.

Cartridge status and tape alert flags page 32, in accordance with the standard, is a 32 Byte page with page ID “105.” Cartridge status and tape alert flags page 32 may be used to identify problems that the cartridge has exhibited in previous drive operations. CM tag reader 16 may encrypt the contents of cartridge status and tape alert flags page 32 to prevent unauthorized access to data on the cartridge. CM tag reader 16 also recalculates CRC bytes at the end of cartridge status and tape alert flags page 32 in accordance with the CRC algorithm discussed above.

Suspended append writes page 34, in accordance with the standard, is a 128 Byte page with page ID “107.” Suspended append writes page 34 may be used to identify locations where an append operation was suspended. A cartridge drive may determine whether data that was in the process of being written before being suspended was later written further down the tape of the cartridge. In this case, suspended appended writes page 34 informs a drive as to the location of this subsequent data. CM tag reader 16 may encrypt data of suspended append writes page 34 to prevent access to data of the data cartridge. CM tag reader 16 also recalculates CRC bytes at the end of suspended append writes page 34 in accordance with the CRC algorithm discussed above.

Error location page 36 exists in LTO cartridges of generation three, but not generations one and two. Thus, when CM tag reader 16 determines that CM chip 20 is of a generation three cartridge, CM tag reader 16 may modify error location page 36. However, when CM tag reader 16 determines that CM chip 20 is of a generation one or two cartridge, CM tag reader 16 may not attempt to locate or modify an error location page. Error location page 36 generally is used to identify any unrecovered errors in CM chip 20 that occurred during any read or write operation. CM tag reader 16 may encrypt error location page 36 to prevent access to data of the data cartridge. CM tag reader 16 also recalculates CRC bytes and writes the recalculated CRC bytes to error location page 36.

CM tag reader 16 may modify a plurality of the pages, as discussed above. In one embodiment, CM tag reader 16 may only modify a single page. In another embodiment, CM tag reader 16 may modify each of the pages as described above. In another embodiment, CM tag reader 16 may modify only a subset of the pages described above. For example, CM tag reader 16 may modify (e.g., encrypt and/or move) unprotected-page table 22, tape write pass page 26, and end-of-data page 30. As another example, CM tag reader 16 may modify initialization page 24 (as discussed in greater detail with respect to FIG. 3), tape directory page 28, cartridge status and tape alert flags page 32, and error location page 36. As another example, CM tag reader 16 may remove unprotected-page table 22 from CM chip 20 and store unprotected-page table 22 to a memory, such as a database, and modify tape directory page 28 and suspended append writes page 34. Other embodiments may modify other combinations of the pages. This disclosure contemplates modification of any combination of the pages illustrated in FIG. 2.

FIG. 3 is a block diagram illustrating an example initialization page 24 of CM chip 20. FIG. 3 illustrates a portion of initialization page 24 of CM chip 20. An initialization page, in general, is present in generations one, two, and three of an LTO-CM chip. In one embodiment, CM chip 20 may correspond to another generation of an LTO data cartridge, in which case CM chip 20 may instead include a similar writeable page, rather than initialization page 24. Similar techniques may apply to other pages shown in FIG. 2.

In accordance with the standard, initialization page 24 is a 64 Byte page of page ID “101” in decimal. Initialization page 24 includes fields such as format type 40 (2 Bytes), begin tape 42 (4 Bytes), begin servo 44 (4 Bytes), begin data 46 (4 Bytes), end data 48 (4 Bytes), end servo 50 (4 Bytes), end tape 52 (4 Bytes), and CRC 54 (4 Bytes), among other fields. In general, fields 42-52 store information regarding “linear positions” (LPOS) of the tape of the cartridge.

In one embodiment, CM tag reader 16 may encrypt initialization page 24 in place. In another embodiment, CM tag reader 16 may move the contents of page 24 to empty pages 38 (FIG. 2). In another embodiment, CM tag reader 16 may encrypt the data of initialization page 24 and store the encrypted data in empty pages 38. In any case, CM tag reader 16 may also recalculate data of CRC 54, in accordance with the CRC algorithm discussed above.

In another embodiment, CM tag reader 16 may modify certain linear position data of initialization page 24. In accordance with the standard, each of the linear positions may increase in a non-zero sequence. That is, if the data of begin tape 42 is equal to “N”, begin servo 44 may store data N+A, begin data 46 may store data N+B, end data 48 may store data N+C, end servo 50 may store data N+D, and end tape 52 may store data N+E, where 0<A<B<C<D<E. Thus, CM tag reader 16 may modify the linear positions such that this property is true but so that the linear positions do not accurately reflect the true positions of data stored on the tape of the data cartridge. In this manner, CM tag reader 16 may prevent access to data of the data cartridge. Moreover, CM tag reader 16 recalculates CRC 54 in accordance with the CRC algorithm discussed above.

In another embodiment, CM tag reader 16 may modify data of format type 40. In accordance with the LTO-CM standard, format type 40, byte 0, bit 6 indicates whether the data cartridge is vendor specific or not. In particular, when this bit is set to a value of “1.” the data cartridge is determined to be vendor specific, whereas when this bit is set to a value of “0,” the data cartridge is determined not to be vendor specific. In accordance with the standard, a drive is not supposed to read or write data to a data cartridge that is vendor specific. Therefore, when this bit is not set to a value of“1,” CM tag reader 16 may toggle the value of this bit, i.e., set the value to “1.” In this manner, CM tag reader 16 may prevent access to data stored on the data cartridge and writes to the data cartridge. CM tag reader 16 also recalculates CRC 54, in accordance with the CRC algorithm discussed above, to ensure that the CRC check is valid.

In another embodiment, CM tag reader 16 encrypts data of format type 40, while leaving the rest of the fields of initialization page 24 intact, other than data of CRC 54, which CM tag reader 16 may recalculate. In this manner, CM tag reader 16 may prevent unauthorized access, i.e., reads and writes, to data on the data cartridge, because a drive may not be able to recognize the format type of the data cartridge.

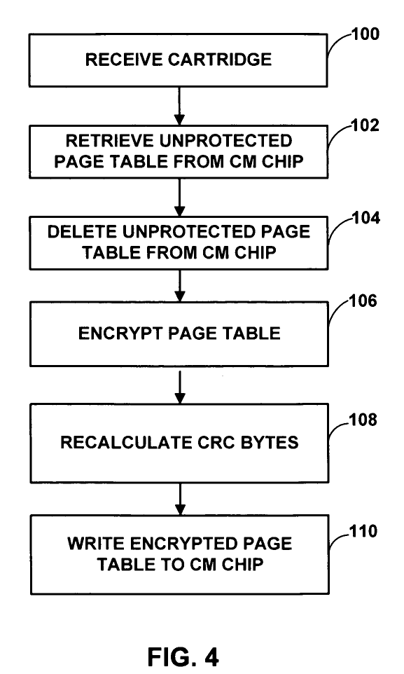

FIG. 4 is a flowchart illustrating an example method for protecting data on LTO cartridge 16. Although the example method of FIG. 4 is described with respect to CM tag reader 16 of FIG. 1, any CM reader may perform similar methods. For example, the method may be performed by a CM tag reader of an LTO cartridge drive.

Initially, CM tag reader 16 receives a cartridge, such as cartridge 12 (FIG. 1), that includes a CM chip, such as CM chip 14 (FIG. 1) or CM chip 20 (FIG. 2) (100). A cartridge may be placed on or over CM tag reader 16 within range of the RFID signal, e.g., 10 mm. In an alternative embodiment, the cartridge may be inserted into a cartridge drive that includes a CM tag reader. In any case, CM tag reader 16 may receive a cartridge including a CM chip, and CM tag reader 16 may read the CM chip.

In the example method of FIG. 4, CM tag reader 16 may then read the unprotected-page table, e.g., unprotected-page table 22 of CM chip 20 of FIG. 2, from the CM chip (102). CM tag reader 16 may retain a local copy of the unprotected-page table, e.g., stored in memory of CM tag reader 16, stored in memory of computing device 10, stored in memory of a local or remote database, or stored in another location separate from the CM chip. In one embodiment, the copy of the unprotected-page table may be stored in the separate location until the cartridge needs to be made accessible. In one embodiment, the local copy may be used for storing a copy of the unprotected-page table, e.g., in an empty page of the CM chip or on the tape of the cartridge itself. In any case, CM tag reader 16 may delete the unprotected-page table from the CM chip (104).

In the example of FIG. 4, CM tag reader 16 may encrypt the unprotected-page table (106). In one embodiment, CM tag reader 16 may encrypt the unprotected-page table in accordance with a password-based encryption scheme, where CM tag reader 16 receives a password from a user, e.g., through computing device 10, then CM tag reader 16 encrypts the unprotected-page table with the received password. CM tag reader 16 may also use a different encryption scheme to encrypt the unprotected-page table.

CM tag reader 16 then recalculates CRC data of the unprotected-page table (108). CM tag reader 16 may calculate the CRC data using Reed-Solomon codes over GF-286. In this manner, CM tag reader 16 may protect data of the data cartridge by modifying the unprotected-page table of the CM chip, such that a cartridge drive will not be able to access the data cartridge, i.e., read data from or write data to the data cartridge.

CM tag reader 16 may then write the encrypted unprotected-page table to an empty page of the CM chip, e.g., at the end of the CM chip (110). CM tag reader 16 also writes the recalculated CRC bytes to the end of the encrypted portion of the unprotected-page table without encrypting the CRC bytes. In one embodiment, CM tag reader 16 may additionally, or alternatively, store the encrypted page table to the data cartridge itself. In an alternative embodiment, CM tag reader 16 may store the encrypted page table back to the original location of the encrypted page table. Similar methods to that described with respect to FIG. 4 may apply with respect to any of the modifiable pages of the CM chip that may be encrypted, as discussed with respect to FIGS. 2 and 3.

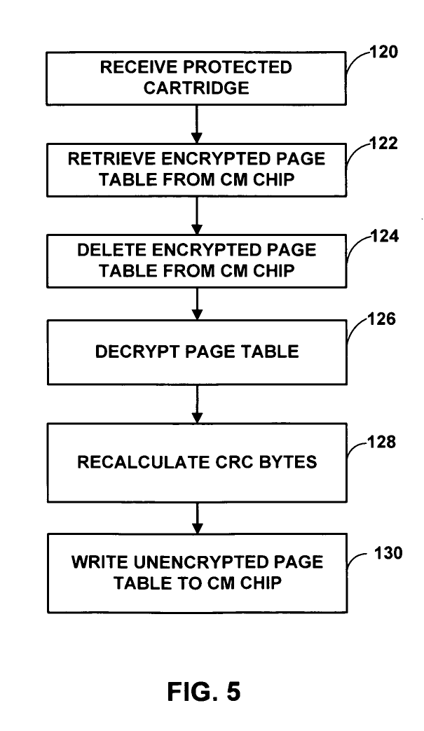

FIG. 5 is a flow chart illustrating an example method for reversing the protective measures discussed with respect to FIG. 4. A CM tag reader, such as CM tag reader 16 of FIG. 1, may first receive a protected data cartridge (120). The CM tag reader may then retrieve the encrypted page table from the CM chip of the protected data cartridge (122). The CM tag reader may also delete the encrypted page table from the CM chip (124).

The CM tag reader may then decrypt the encrypted page table to restore the unprotected-page table to its original form (126). In one embodiment, CM tag reader may receive a password from a user via, e.g., computing device 10 (FIG. 1). In order to decrypt the encrypted page table, the password may need to be identical to a password used to encrypt the unprotected-page table.

Once the unprotected-page table has been decrypted, the CM tag reader may recalculate CRC bytes to ensure the validity of the unprotected-page table (128). The CM tag reader may then store the unprotected-page table to the proper location of the CM chip, with the recalculated CRC bytes appended to the end (130). After the unprotected-page table is restored, the data cartridge may then be readable by cartridge drives generally, and the data of the data cartridge is no longer protected. Similar methods may be applied to reverse the encryption of other pages of the CM chip, as discussed with respect to FIGS. 2 and 3.

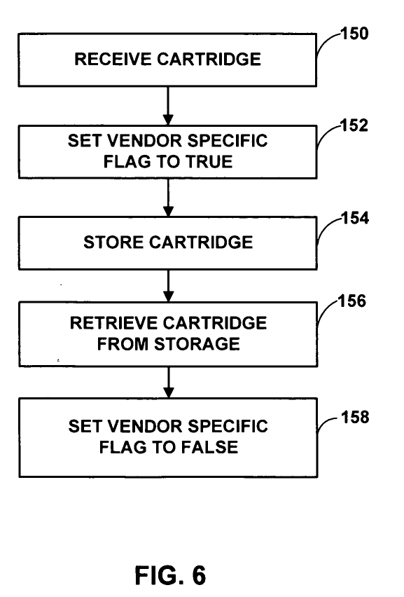

FIG. 6 is a flowchart that illustrates an example method for protecting a data cartridge by setting a vendor specific flag. Initially, a CM tag reader receives a cartridge that includes a CM chip (150). The CM tag reader may first determine whether the cartridge has already been set as vendor specific, e.g., by examining a flag that indicates whether the cartridge is vendor specific. In LTO generations one, two, and three, for example, the vendor specific flag is byte 0, bit 6 of format type 40 bytes of initialization page 24 (FIGS. 2 and 3). In other LTO generations, the vendor specific flag may be at another location, e.g., byte 0 bit 4 of a writeable contents page.

In accordance with the LTO-CM standard, a cartridge drive is not supposed to operate on a cartridge that is vendor specific. Therefore, to protect the data of the data cartridge, the CM tag reader may set the vendor specific flag to true (152), to indicate that the data cartridge is vendor specific. The CM tag reader may also recalculate CRC bytes at the end of the corresponding page to maintain the validity of the page. The data cartridge may then be stored (154), e.g., in a remote location, and the data of the data cartridge will be protected. A cartridge drive may be unaware of the protections, and may be unable to access the data cartridge until the CM reader reverses the protections. At the same time, however, the techniques of this disclosure may ensure that a cartridge drive does not misinterpret the protections to think that the CM chip is corrupted or erroneous. In this way, unwanted overwrites of the CM chip can be avoided while maintaining data protections that render the data of the data cartridge inaccessible to some or all conventional drives.

To reverse the protection and to enable reading of the data of the data cartridge, the data cartridge may be retrieved from the storage location (156). The CM tag reader may then set the vendor specific flag to false (158), to enable reads of data of the data cartridge. The CM tag reader may also recalculate CRC bytes of the corresponding page of the CM chip to show that data of the CM chip is valid.

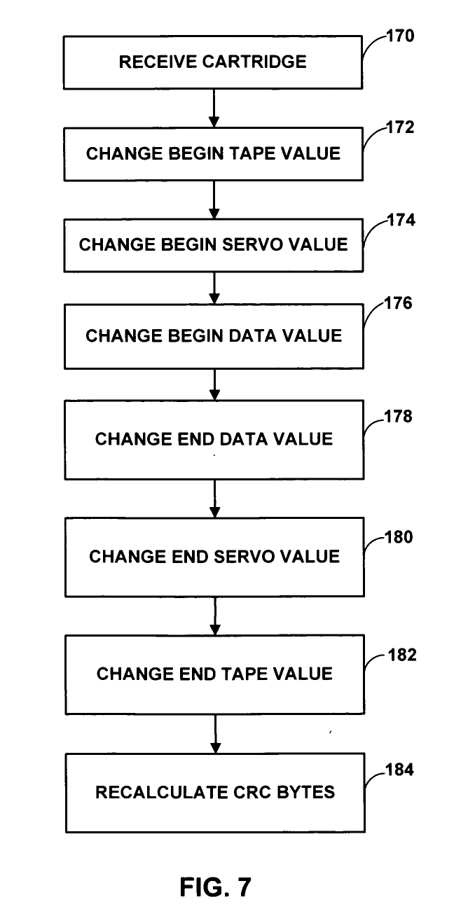

FIG. 7 is a flowchart illustrating an example method for protecting a data cartridge by changing linear position values of an initialization page of a CM chip. Initially, a CM tag reader may receive a cartridge that includes a CM chip (170). The CM tag reader may then locate and identify an initialization page of the CM chip if the cartridge is an LTO generation one, two, or three cartridge. The CM tag reader may instead locate and identify a similar, writeable contents page when the cartridge is a different LTO generation cartridge.

In any case, the CM tag reader may locate a begin tape linear position value, e.g., in the initialization page of the CM chip. The CM tag reader may then modify the value of the begin tape linear position value (172). In one embodiment, the CM tag reader may, instead, leave the begin tape linear position value unchanged, but change at least one of the other five linear position values, as discussed below.

The CM tag reader may then modify one or more of the begin servo linear position value (174), the begin data linear position value (176), the end data linear position value (178), the end servo linear position value (180), and the end tape linear position value (182). The modifications to these linear position values may satisfy the property that the values increase in a non-zero sequence, to avoid data on the data cartridge being overwritten. For example, assuming that the value of the begin tape linear position as modified is an integer N, the modified value of the begin servo linear position may be N+A, the modified value of the begin data linear position may be N+B, the modified value of the end data linear position may be N+C, the modified value of the end servo linear position may be N+D, and the modified value of the end tape linear position may be N+E, where A, B, C, D, and E are integers and 0<A<B<C<D<E. In one embodiment, B=2*A, C=3*A, D=4*A, and E=5*A. In another embodiment, B=2+A, C=3+A, D=4+A, and E=5+A. In another embodiment, the values of the linear positions may each be offset by a standard value from their original values, e.g., the modified begin tape linear position value may be the original begin tape linear position value plus a nonzero integer X. In another embodiment, each of the values of A, B, C, D, and E may be preselected and consistently applied to protect all cartridges. In another embodiment, a mathematical algorithm may be applied to values of the CM chip to select values for A, B, C, D, and E, such that the values can later be retrieved and the process reversed. In other embodiments, other methods for selecting modified values for the linear positions may be used.

After the values for the linear positions have been modified, the CM tag reader may also recalculate the CRC bytes of the corresponding page to ensure the validity of data of the page (184). In this manner, the CM tag reader may protect data of the data cartridge from unauthorized access, i.e., reads and writes.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components, embodied in programmers, such as physician or patient programmers, stimulators, image processing devices or other devices. The term “processor” or “processing circuitry” may generally refer to any of the foregoing logic circuitry, alone or in combination with other logic circuitry, or any other equivalent circuitry.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units may be realized by separate hardware or software components. Rather, functionality associated with one or more modules or units may be performed by separate hardware or software components, or integrated within common or separate hardware or software components.

The techniques described herein may also be embodied in a computer readable medium containing instructions. Instructions embedded in a computer readable medium may cause a programmable processor, or other processor, to perform the method, e.g., when the instructions are executed. A computer readable medium may be a computer readable storage medium. Computer readable storage media may include, for example, random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As noted, the techniques described herein have been described with respect to a Linear Tape-Open (LTO) data cartridge. However, similar techniques may be applied to other types of data cartridges. For example, similar techniques are applicable to IBM 3592 data cartridges and Sun T10000 data cartridges. Moreover, the techniques may be performed by a stand-alone CM tag reader or an RFID reader that is associated with a cartridge drive. The CM tag reader may be a stand-alone device, or also associated with a computing device, such as computing device 10 of FIG. 1.

In still other cases, the protection and reversing techniques applied by a CM tag reader may be incorporated directly into a drive. In this case, the drive itself may have the protection and reversing capabilities described herein. For example, computing device 10 and CM tag reader 16 of FIG. 1 could be implemented entirely within a tape drive that reads and writes to cartridge 12.

Various embodiments of the invention have been described. These and other embodiments are within the scope of the following claims.

1. A method comprising:
reading a cartridge memory chip associated with a data cartridge; and
modifying a portion of memory of the chip to prevent unauthorized access to data of the data cartridge, without rendering the modification irreversible.

2. The method of claim 1, further comprising reversing the modification to the portion of memory of the chip to permit reading of the data of the cartridge.

3. The method of claim 1, wherein modifying a portion of memory of the chip comprises encrypting an unprotected-page table of the chip.

4. The method of claim 1, wherein modifying a portion of memory of the chip comprises:
identifying a location of an initialization page of the chip;
identifying an empty page of the chip;
copying the initialization page to the empty page; and
deleting the initialization page from the identified location.

5. The method of claim 4, wherein copying the initialization page further comprises encrypting the initialization page and storing the encrypted initialization page to the empty page.

6. The method of claim 1, wherein modifying a portion of memory of the chip comprises:
determining whether a vendor-specific-identifier of a page of the chip is set to identify the cartridge as vendor specific; and
when the vendor-specific-identifier is not set to identify the cartridge as vendor specific:
changing the vendor-specific-identifier to identify the cartridge as vendor specific; and
resetting cyclical redundancy check (CRC) bytes of the page to reflect the changes to the vendor-specific-identifier.

7. The method of claim 6, wherein reading a cartridge memory chip associated with a data cartridge comprises reading a cartridge memory chip associated with a Linear Tape-Open (LTO) data cartridge, the method further comprising
identifying a generation of the cartridge from the cartridge memory chip:
when the generation of the cartridge is equal to generation one, generation two, or generation three, wherein changing the vendor-specific-identifier to identify the cartridge as vendor specific comprises setting byte 0 bit 6 of format type bytes of an initialization page; and
when the generation of the cartridge is equal to a different generation, changing the vendor-specific-identifier to identify the cartridge as vendor specific comprises setting byte 0 bit 4 of a writeable contents page.

8. The method of claim 1, wherein modifying a portion of memory of the chip comprises modifying a sequence of linear position numbers of an initialization page of the chip, wherein the linear position numbers comprise at least one of a begin-tape number, a begin-servo number, a begin-data number, an end-data number, an end-servo number, and an end-tape number.

9. The method of claim 1, wherein modifying a portion of the memory of chip comprises encrypting format type bytes of an initialization page of the chip and resetting CRC bytes of the initialization page.

10. The method of claim 1, wherein modifying a portion of the memory of chip comprises encrypting a tape write pass page.

11. The method of claim 1, wherein modifying a portion of the memory of chip comprises encrypting a table directory page.

12. The method of claim 1, wherein modifying a portion of the memory of chip comprises encrypting an end-of-data page.

13. The method of claim 1, wherein modifying a portion of the memory of chip comprises encrypting a cartridge status and tape alert flags page.

14. The method of claim 1, wherein modifying a portion of the memory of chip comprises encrypting a suspended append writes page.

15. The method of claim 1, wherein reading a cartridge memory chip associated with a data cartridge comprises reading a cartridge memory chip associated with a Linear Tape-Open (LTO) data cartridge, the method further comprising identifying a generation of the cartridge from the cartridge memory chip; and
when the generation of the cartridge is equal to generation three, modifying a portion of the memory of chip comprises encrypting an error location page.

16. A system comprising:
a data cartridge comprising a cartridge memory chip;
a chip reader to read data from the cartridge memory chip and to write data to the cartridge memory chip; and
a computing device to control the chip reader, wherein the computing device causes the chip reader to read data from the cartridge memory chip of the data cartridge and to modify a portion of memory of the chip to prevent reads from and writes to the data cartridge, without rendering the modification irreversible.

17. The system of claim 16, wherein the computing device causes the chip reader to encrypt at least one of an unprotected-page table, an initialization page, a tape write pass page, a tape directory page, an end-of-data page, a cartridge status and tape alert flags page, a suspended append writes page, an error location page, and a writeable contents page of the cartridge memory chip, and to reset cyclical redundancy check (CRC) bytes of an encrypted page of the cartridge memory chip.

18. The system of claim 16, wherein the computing device causes the chip reader to modify at least one of a begin-tape number, a begin-servo number, a begin-data number, an end-data number, an end-servo number, and an end-tape number to increase in a non-zero sequence of an initialization page of the cartridge memory chip.

19. A data cartridge comprising:
a magnetic tape to store data; and
a cartridge memory chip, wherein the cartridge memory chip includes at least one page that does not conform to a standard for the data cartridge, wherein the at least one non-standard page prevents a cartridge drive from reading the data stored on the magnetic tape and prevents the cartridge drive from writing data to the magnetic tape, wherein the at least one non-standard page can be modified to allow reading of the data stored on the magnetic tape.

20. A computer-readable medium comprising instructions for causing a programmable processor to:
read a cartridge memory chip associated with a data cartridge; and
modify a portion of memory of the chip to prevent access to data of the data cartridge, without rendering the modification irreversible.
